(19) United States
(12) Patent Application Publication
(10) Pub. No.: US 2026/0098835 A1
(43) Pub. Date: Apr. 9, 2026

(54) DUAL ULTRASONIC DETECTION DEVICE

(71) Applicant: SHENZHEN KEWEI NEO_TECH CO., LTD., SHENZHEN CITY (CN)

(72) Inventor: LIQUN YU, WUHAN CITY (CN)

(21) Appl. No.: 19/023,348

(22) Filed: Jan. 16, 2025

(30) Foreign Application Priority Data
Oct. 9, 2024 (CN) 202422424625.2

(51) Int. Cl. G01N 29/024; G01N 29/22

(52) U.S. Cl. CPC G01N 29/024; G01N 29/221; G01N 29/222; G01N 2291/045

(57) ABSTRACT

A dual ultrasonic detection device includes a housing having a detection chamber for containing a liquid to be measured; a first ultrasonic reflector disposed on a rigid side wall of the detection chamber; a first ultrasonic detector disposed on a side wall of the detection chamber and opposite to the first ultrasonic reflector, and configured to obtain a first flight time corresponding to ultrasonic waves transmitted to the first ultrasonic reflector and reflected back; a second ultrasonic reflector disposed on an elastic side wall of the detection chamber, a distance of an outward expansion of the elastic side wall is related to a pressure exerted by the liquid; a second ultrasonic detector disposed on the side wall and opposite to the second ultrasonic reflector, and configured to obtain a second flight time corresponding to ultrasonic waves transmitted to the second ultrasonic reflector and reflected back.

### FIELD OF THE DISCLOSURE

The invention pertains to the technical field of ultrasonic detection of material characteristics, and specifically to a dual ultrasonic detection device.

### BACKGROUND OF THE DISCLOSURE

Ultrasonic detection of fluid density or concentration, as well as ultrasonic detection of fluid volume or height, all utilize the principle that the speed of ultrasonic waves varies in fluids of different densities. The specific technical implementation involves using a timing chip to measure the flight time of ultrasonic waves over a fixed distance to determine the density or height of the fluid.

One application scenario of this technology is in the automotive industry, specifically in the exhaust treatment systems of fuel vehicles, where a urea additive (AdBlue) is used to eliminate harmful substances such as nitric oxide or nitrogen dioxide, collectively known as NOx, from the exhaust gases. To achieve precise reactions, it is necessary to measure the concentration of the urea additive and dynamically report the urea liquid level within its container. Current market solutions generally follow two approaches:
1. First Approach: Concentration detection is achieved using ultrasonic technology, while liquid level detection is performed using magnetic reed switches or Hall effect chips in combination with magnetized float rings.
2. Second Approach: Both concentration and liquid level are detected using a dual ultrasonic scheme.

The dual ultrasonic scheme involves two probes working in conjunction with a single control board to accomplish concentration and liquid level height detection. In both cases, the technical method involves directly transmitting ultrasonic waves through the urea liquid. Specifically, the concentration is determined by setting a fixed distance for ultrasonic waves to traverse and measuring the flight time, whereas the liquid level height is measured by determining the flight time of ultrasonic waves reaching the liquid surface.

Because the dual ultrasonic scheme shares the same application scenario, core technology, underlying electronic circuits, and detection logic, hardware resources can be shared at the foundational level. This significantly reduces costs, making it a potential mainstream technology in the future. However, the dual ultrasonic scheme has certain drawbacks:
High Liquid Level: Ultrasonic transmission needs to reach the liquid surface being measured. If the liquid surface is too high or if the liquid surface experiences severe oscillations due to self-excitation caused by the bumps in the vehicle, the returning signals will disperse and become very weak, leading to detection failure or false reporting.
Low Liquid Level: If the liquid level is too low, the free space in the liquid becomes too large, and the liquid surface oscillates violently, resulting in distorted detection values.

### SUMMARY OF THE DISCLOSURE

The objective of the present invention is to address the defects and shortcomings of the prior art by providing a dual ultrasonic detection device applicable to the detection of liquid concentration and liquid level height, thereby improving the accuracy of liquid level measurements.

To achieve the above objective, the technical solution adopted by the present invention is as follows:

A dual ultrasonic detection device, characterized by including:
a housing, having a detection chamber therein for containing a liquid to be measured;
a first ultrasonic reflector, disposed on a rigid side wall of the detection chamber, and configured to reflect an ultrasonic signal;
a first ultrasonic detector, disposed on a side wall of the detection chamber and opposite to the first ultrasonic reflector, and configured to obtain a first flight time corresponding to an ultrasonic wave transmitted to the first ultrasonic reflector and reflected back;
a second ultrasonic reflector, disposed on an elastic side wall of the detection chamber and configured to reflect an ultrasonic signal, wherein a distance of an outward expansion of the elastic side wall is related to a pressure exerted by the liquid to be measured on the outward expansion;
a second ultrasonic detector, disposed on the side wall of the detection chamber and opposite to the second ultrasonic reflector, and configured to obtain a second flight time corresponding to an ultrasonic wave transmitted to the second ultrasonic reflector and reflected back.

Preferably, the elastic side wall of the detection chamber is provided with a pressure-sensitive membrane.

Preferably, the pressure-sensitive membrane includes an elastic metal film.

Preferably, the dual ultrasonic detection device further includes a rear cover, wherein an air cavity is formed between the pressure-sensitive membrane and the rear cover; a liquid passage passes through the housing, the liquid passage is in communication with the detection chamber, with a liquid inlet formed at a bottom of the housing and a liquid outlet formed at a top of the housing; the housing further includes a first through hole through which the liquid to be measured contacts the pressure-sensitive membrane.

Preferably, the housing is provided with a groove, within which a first sealing ring is disposed, and the first sealing ring is abutted against both the housing and the rear cover.

Preferably, a flat surface is provided at a center of the pressure-sensitive membrane, and the flat surface transitions to a skirt that is outermost via a corrugated region.

Preferably, the second ultrasonic reflector includes a metal sheet embedded in the flat surface at the center of the pressure-sensitive membrane.

Preferably, the pressure-sensitive membrane is made of a highly elastic polymer material.

Alternatively, the pressure-sensitive membrane is made of a non-elastic polymer material, the air cavity is provided with a spring, and the spring is abutted against the center of the pressure-sensitive membrane.

Preferably, each of a compression ring and a compression cup is disposed between the housing and the rear cover, and configured to clamp an outer edge of the corrugated region of the pressure-sensitive membrane; the compression ring is abutted against the rear cover, the compression cup is abutted against the housing, a second through hole is formed at a bottom of the compression cup and is in communication with the first through hole, and the skirt of the pressure-sensitive membrane is abutted against each of the outer edge of the compression cup, the housing, and the rear cover.

Preferably, a second sealing ring is provided between the outer edge of the compression cup and the housing.

Preferably, the liquid inlet is provided with a filter.

Preferably, the dual ultrasonic detection device further includes a circuit board, wherein the circuit board includes:
a control module, correspondingly connected to the first ultrasonic detector and the second ultrasonic detector, and configured to receive and process an ultrasonic detection signal;
a timing module, connected to the control module, and configured to provide timing for an ultrasonic distance measurement;
a communication module, connected to the control module, and configured to communicate with a host computer to transmit data and a control signal;
a power module, configured to supply a suitable power voltage to electronic components of the dual ultrasonic detection device.

Preferably, a maximum distance of the outward expansion of the elastic side wall of the detection chamber is less than a product of a second flight velocity that is smallest across a full range and an ultrasonic vibration period, wherein the second flight velocity is defined as a distance between the second ultrasonic reflector and the second ultrasonic detector divided by the second flight time.

### Beneficial Effects of the Invention

By adopting the above technical solutions, embodiments of the present invention inherit the advantages of the dual ultrasonic scheme while employing a pressure transmission mechanism to indirectly detect liquid levels. This approach avoids the distortion of detection values caused by large free spaces and violent liquid surface oscillations at low liquid levels, and it also prevents interference from signal attenuation due to high liquid levels in the measured liquid. Consequently, the accuracy of liquid level height detection is significantly enhanced.

### BRIEF DESCRIPTION OF THE DRAWINGS

In order to more clearly illustrate the embodiments of the present invention or the technical solutions in the prior art, the following provides a brief introduction to the drawings necessary for the description of the embodiments or the prior art. It is evident that the drawings described below are merely some embodiments of the present invention. Those skilled in the art can derive other embodiments based on these drawings without requiring inventive efforts.

FIG. 1: a schematic cross-sectional view of a dual ultrasonic detection device according to some embodiments.

FIG. 2: a three-dimensional view of the dual ultrasonic detection device according to some embodiments.

FIG. 3: a three-dimensional view of the dual ultrasonic detection device from another perspective according to some embodiments.

FIG. 4: a schematic A-A cross-sectional view of the dual ultrasonic detection device according to some embodiments.

FIG. 5: a schematic B-B cross-sectional view of the dual ultrasonic detection device according to some embodiments.

FIG. 6: a schematic C-C cross-sectional view of the dual ultrasonic detection device according to some embodiments.

FIG. 7: a schematic view of a pressure-sensitive membrane according to some embodiments.

FIG. 8: a schematic cross-sectional view of the pressure-sensitive membrane according to some embodiments.

FIG. 9: a schematic cross-sectional view of the pressure-sensitive membrane and an air cavity according to some embodiments.

FIG. 10: a schematic B-B cross-sectional view of the dual ultrasonic detection device according to some embodiments.

FIG. 11: a block diagram of an electrical hardware of the dual ultrasonic detection device according to some embodiments.

FIG. 12: a schematic view of an ultrasonic detection window according to some embodiments.

### LIST OF REFERENCE NUMERALS

100: Housing.
110: Detection Chamber
120: Pressure-Sensitive Membrane
121: Flat Surface
122: Corrugated Region
123: Skirt
130: Rear Cover.
131: Compression Ring
132: Compression Cup
133: Second Through Hole
140: Air Cavity
141: Spring
150: Liquid Passage
151: Liquid Inlet
152: Liquid Outlet
160: First Through Hole
170: Groove
171: First Sealing Ring
180: Filtration Cavity
181: Filter
200: First Ultrasonic Reflector
300: First Ultrasonic Detector
400: Second Ultrasonic Reflector
500: Second Ultrasonic Detector
600: Circuit Board
610: Control Module
620: Timing Module
630: Communication Module
640: Power Module

### DETAILED DESCRIPTION OF THE EXEMPLARY EMBODIMENTS

The following provides a further detailed description of the present invention in conjunction with the accompanying drawings.

The specific embodiments described herein are for the purpose of explaining the present invention and do not limit the present invention. Those skilled in the art, after reading this specification, can make modifications to these embodiments without requiring inventive contributions, provided they fall within the scope of the claims of the present invention and are protected by patent law.

The present invention pertains to a dual ultrasonic detection device used for detecting liquid concentration and liquid level height, thereby significantly enhancing the accuracy of liquid level measurements.

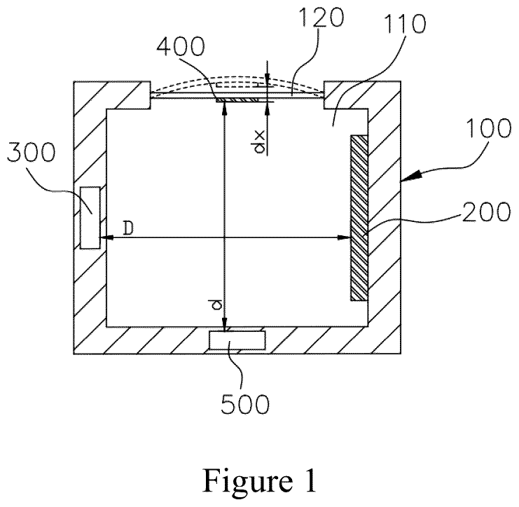

Referring to FIG. 1, an embodiment of the dual ultrasonic detection device includes a housing (100), a first ultrasonic reflector (200), a First ultrasonic detector (300), a second ultrasonic reflector (400), and a second ultrasonic detector (500).

The housing (100) has a detection chamber (110) therein for containing a liquid to be measured. In some embodiments, the liquid to be measured is an AdBlue urea solution.

The first ultrasonic reflector (200) is disposed on a rigid side wall of the detection chamber (110) and is configured to reflect an ultrasonic signal. The rigid side wall of the detection chamber (110) does not undergo state changes with variations in the liquid level height of the contained liquid. In some embodiments, the first ultrasonic reflector (200) may be a metal reflector plate.

The first ultrasonic detector (300) is disposed on a side wall of the detection chamber (110) and opposite to the first ultrasonic reflector (200). The first ultrasonic detector (300) is configured to transmit a first ultrasonic detection signal through the liquid to be measured to the first ultrasonic reflector (200) and receive a signal reflected by the first ultrasonic reflector (200), thereby obtaining a first flight time tfc corresponding to the ultrasonic wave traveling to the first ultrasonic reflector (200) and reflecting back. The first flight velocity V₁ of the transmitted ultrasonic wave in the liquid to be measured is V₁=D₁/tfc, where D₁ is a first flight distance and a value of D₁ is twice a distance D between the first ultrasonic reflector (200) and the first ultrasonic detector (300). Since the first flight velocity V₁ is related to both the concentration of the liquid to be measured (and the current ambient temperature T, knowing the current ambient temperature T allows for the determination of the concentration of the liquid to be measured (by measuring the first flight velocity V₁.

The second ultrasonic reflector (400) is disposed on an elastic side wall of the detection chamber (110) and is configured to reflect an ultrasonic signal. A distance dx of an outward expansion of the elastic side wall of the detection chamber (110) is related to a pressure exerted by the liquid to be measured on the outward expansion. Since the pressure exerted on the elastic side wall is related to a liquid pressure at that location, and the liquid pressure is related to both the liquid density and the distance from that location to a liquid surface, the liquid level height H can be obtained by measuring the distance dx of the outward expansion of the elastic side wall, in conjunction with the concentration of the liquid to be measured (previously measured.

The second ultrasonic detector (500) is disposed on the side wall of the detection chamber (110) and opposite to the second ultrasonic reflector (400). The second ultrasonic detector (500) is configured to transmit a second ultrasonic detection signal through the liquid to be measured to the second ultrasonic reflector (400) and receive a signal reflected by the second ultrasonic reflector (400), thereby obtaining a second flight time tfh corresponding to the ultrasonic waves traveling to the second ultrasonic reflector (400) and reflecting back. The second flight velocity of the transmitted ultrasonic waves in the liquid is V₂=D₂/tfh. D₂ is a second flight distance and a value of D₂ is twice a distance between the second ultrasonic reflector (400) and the second ultrasonic detector (500), which equals to twice a sum of a distance between the second ultrasonic reflector (400) and the second ultrasonic detector (500) when the detection chamber (110) is not containing liquid, and the outward expansion distance of the elastic side wall due to the pressure exerted by the liquid to be measured. If the second ultrasonic detector (500) transmits the same ultrasonic wave as the first ultrasonic detector (300), the first flight velocity V₁ and the second flight velocity V₂ are identical. Therefore, with the current ambient temperature T′ and the concentration of the liquid to be measured (previously measured, the liquid level height H of the liquid to be measured can be further obtained by measuring the second flight time tfh. In some embodiments, the ultrasonic waves transmitted by the second ultrasonic detector (500) may differ from those transmitted by the first ultrasonic detector (300), and the results can be obtained through certain numerical transformations.

Embodiments of the present invention, inheriting the advantages of the dual ultrasonic scheme, adopt a pressure transmission mechanism to indirectly detect the liquid level. This approach offers significant advantages by avoiding the distortion of detection values caused by large free spaces and violent liquid surface oscillations at low liquid levels, and by preventing interference from signal attenuation due to high liquid levels in the measured liquid. Consequently, the accuracy of liquid level height detection is significantly enhanced.

In another embodiment, the elastic side wall (110) of the detection chamber includes a pressure-sensitive membrane (120). One side of the pressure-sensitive membrane (120) is in contact with the liquid to be measured, and the other side is in contact with air. The pressure-sensitive membrane (120) expands towards the air side as the liquid level of the contained liquid to be measured rises.

In another embodiment, the pressure-sensitive membrane (120) is an elastic metal film. In some embodiments, it can be integrally formed with the second ultrasonic reflector (400).

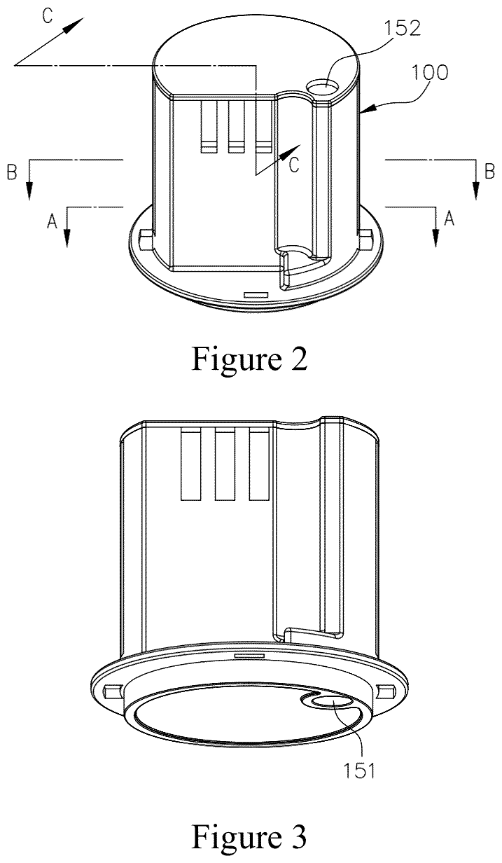

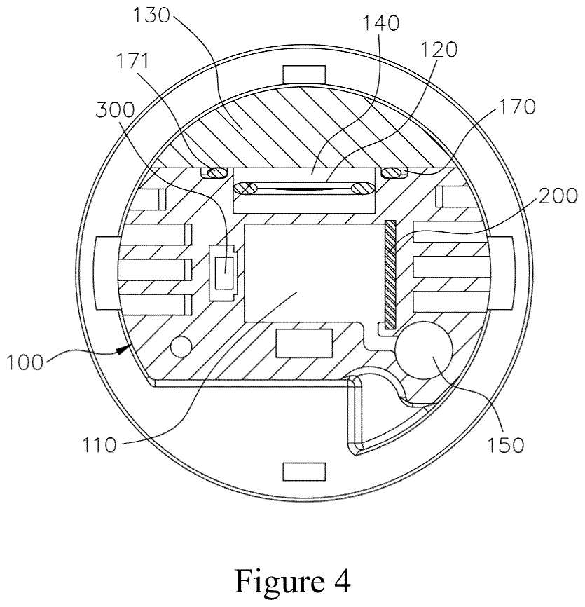

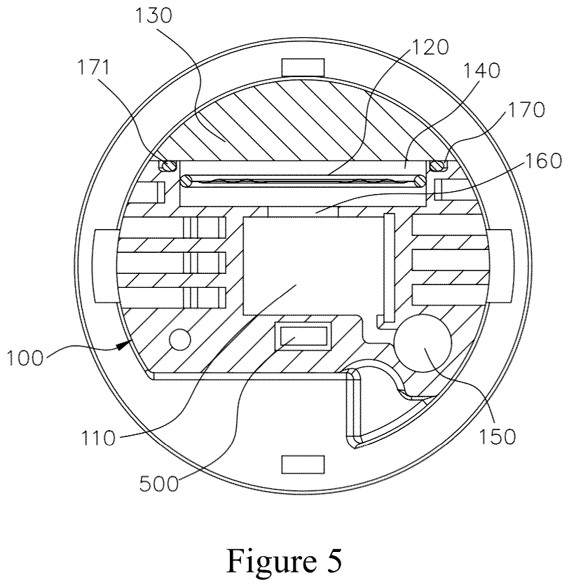

Referring to FIGS. 2 to 6, in another embodiment, the dual ultrasonic detection device further includes a rear cover (130). An air cavity (140) is formed between the pressure-sensitive membrane (120) and the rear cover (130). A liquid passage (150) passes through the housing (100), and is in communication with the detection chamber (110). A liquid inlet (151) is formed at a bottom of the housing (100), and a liquid outlet (152) is formed at a top of the housing (100). Additionally, the housing (100) is provided with a first through hole (160), through which the liquid to be measured contacts the one side of the pressure-sensitive membrane (120). In this embodiment, the dual ultrasonic detection device can be inserted as a single probe into the liquid to be measured, and sinking to a bottom of a container holding the liquid to be measured. The liquid to be measured flows into the detection chamber (110) through the liquid inlet (151) at a bottom of the liquid passage (150) and can overflow from the liquid outlet (152). Ultrasonic detection of concentration and liquid level height can be performed regardless of whether the liquid level of the liquid to be measured is above or below the height of the housing (100). The pressure-sensitive membrane (120) expands towards the air cavity (140) under the pressure of the liquid level to be measured.

In another embodiment, the housing (100) is provided with a groove (170), within which a first sealing ring (171) is disposed. The first sealing ring (171) is abutted against both the housing (100) and the rear cover (130). The first sealing ring (171) seals the air cavity (140).

In some embodiments, the housing (100) and the rear cover (130) can be fixed together using bolts.

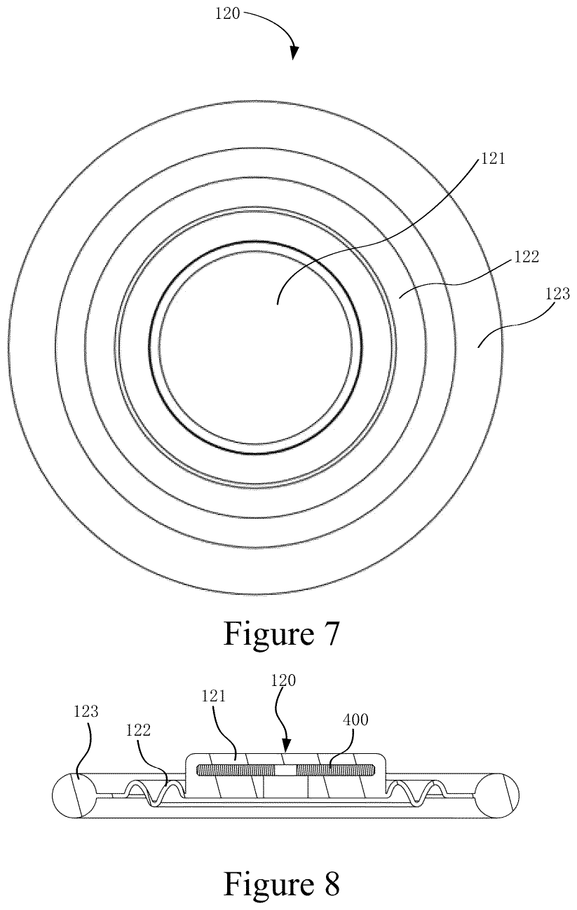

Referring to FIG. 7, in another embodiment, a flat surface (121) is provided at a center of the pressure-sensitive membrane (120), and the flat surface (121) transitions to a skirt (123) that is outermost via a corrugated region (122). The skirt (123) is used for sealing the area and fixing the pressure-sensitive membrane (120).

Referring to FIG. 8, in another embodiment, the second ultrasonic reflector (400) is a metal sheet embedded in the flat surface (121) at the center of the pressure-sensitive membrane (120), and configured to reflect ultrasonic signals.

In a specific implementation, the material of the pressure-sensitive membrane (120) is a highly elastic polymer material.

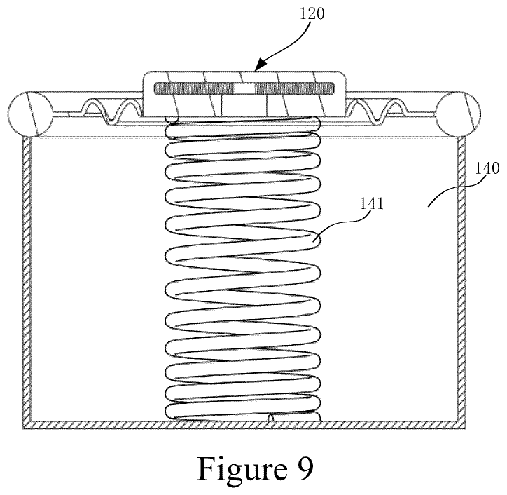

Referring to FIG. 9, in another embodiment, the material of the pressure-sensitive membrane (120) is a non-elastic polymer material. The air cavity (140) is provided with a spring (141), which is abutted against the center of the pressure-sensitive membrane (120). The spring (141) provides elastic support to the non-elastic pressure-sensitive membrane (120).

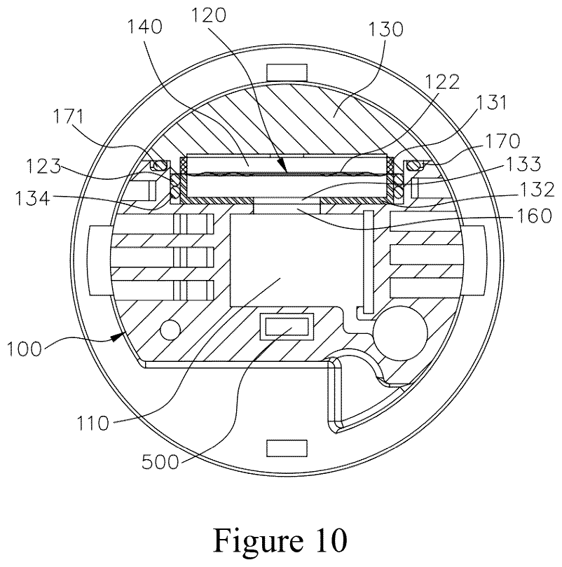

Referring to FIG. 10, in another embodiment, each of a compression ring (131) and a compression cup (132) is disposed between the housing (100) and the rear cover (130). These components are configured to clamp an outer edge of the corrugated region (122) of the pressure-sensitive membrane (120). Specifically, the compression ring (131) is abutted against the rear cover (130), and the compression cup (132) is abutted against the Housing (100). A second through hole (133) is formed at a bottom of the compression cup (132), which is in communication with the first through hole (160). Additionally, the skirt (123) of the pressure-sensitive membrane (120) is abutted against each of the outer edge of the compression cup (132) and the housing (100) and the rear cover (130).

In another embodiment, a second sealing ring (134) is provided between the outer edge of the compression cup (132) and the housing (100). The second sealing ring (134) serves to further seal the liquid to be measured, ensuring no leakage occurs.

Referring to FIG. 3, in another embodiment, the liquid inlet (152) is equipped with a filter (not shown in the figures). The filter serves to filter out bubbles or dust particles, preventing them from entering the detection area and thereby ensuring accurate ultrasonic measurements.

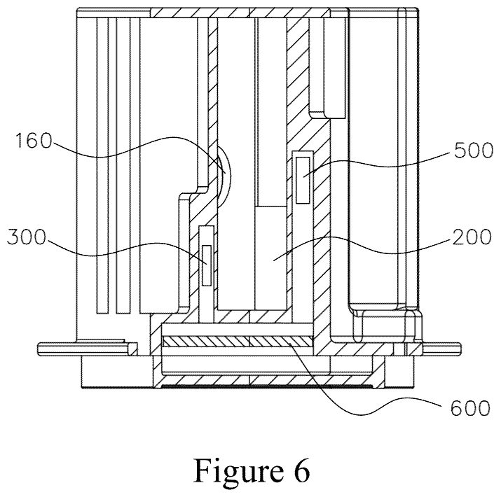

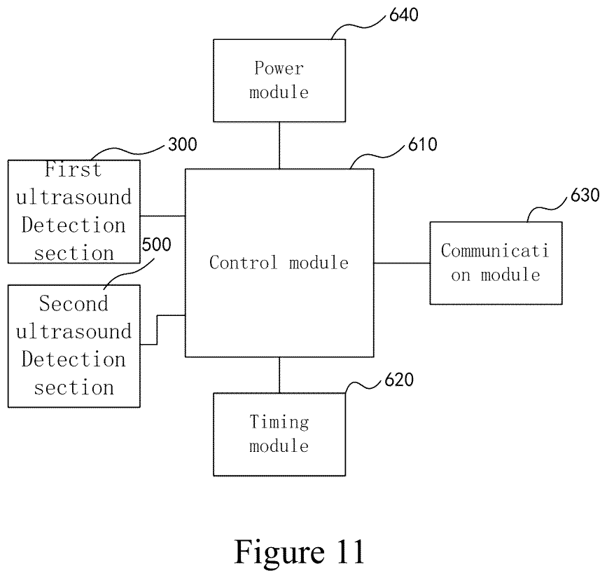

Referring to FIGS. 6 and 11, in another embodiment, the device further includes a circuit board (600). The circuit board (600) is equipped with:
a control module (610), correspondingly connected to the first ultrasonic detector (300) and the second ultrasonic detector (500), and configured to receive and process an ultrasonic detection signal. In some embodiments, the control module (610) may utilize an MCU controller;
a timing module (620), connected to the control module (610), and configured to provide timing for an ultrasonic distance measurement. In some embodiments, the timing module (620) may be integrated into the control module (610);
a communication module (630), connected to the control module (610), and configured to communicate with a host computer to transmit data and a control signal. In some embodiments, the communication module (630) transmits control information and parameters or variables via the J1939 protocol. In some embodiments, the communication module (630) may be integrated into the control module (610);
a power module (640), configured to supply suitable power voltages to electronic components of the dual ultrasonic detection device.

In another embodiment, a maximum distance dxₘₐₓ of the outward expansion of the elastic side wall (110) of the detection chamber does not exceed a product of a smallest second flight velocity V 2 min within a full range and the ultrasonic vibration period.

Under these constraints, the following condition holds:

$${T}_{c} \geq \frac{d + {dx}_{max}}{{V}_{2 m i n}} - \frac{d}{{V}_{2 m i n}} , \frac{d + {dx}_{max}}{{V}_{2 m i n}}$$

corresponds to half the maximum time tfh_{V2max} of the second flight path in the entire value domain under the minimum second flight speed condition. Similarly,

$$\frac{d}{{V}_{2 m i n}}$$

corresponds to half the minimum time tfh_{V2min} of the second flight path in the entire value domain under the minimum second flight speed condition. Thus,

$${T}_{c} \geq \frac{1}{2} ( {tfh}_{V2 max} - {tfh}_{V2 min} )$$

is obtained. This design ensures that the requirements on circuit hardware noise ratio are relaxed when measuring ultrasonic flight time.

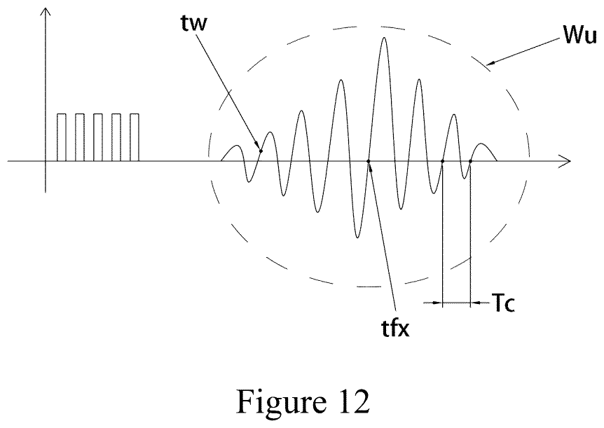

Referring to FIG. 12, a window time tw is positioned in the middle of the ultrasonic packet Wu, further avoiding sampling in the low signal-to-noise ratio region in front of the first wave. The implementation of this strategy includes the following key points:
1. The system is designed so that the result of the flight time detection falls within a narrow spatial range T_{c};
2. After triggering the ultrasonic packet, the software controls the zero-crossing amplitude and ensures only one flight time detection value tfx;
3. The detected tfx continuously reduces until:

$$\frac{1}{2} {tfh}_{V 2 min} \leq tfx \leq \frac{1}{2} {tfh}_{V 2 max} ,$$

where the true value can be obtained.

In some embodiments, the first ultrasonic detection unit 300 and the second ultrasonic detection unit 500 may utilize ultrasonic flight time (ToF, Time-of-Flight) sensors.

The above description is merely illustrative of the technical solution of the present invention and is not limiting. A person skilled in the art may make modifications or equivalent replacements based on the technical solutions described herein without departing from the spirit and scope of the invention, which are defined by the appended claims.

What is claimed is:

1. A dual ultrasonic detection device, comprising:
a housing having a detection chamber therein for containing a liquid to be measured;
a first ultrasonic reflector disposed on a rigid side wall of the detection chamber and configured to reflect an ultrasonic signal;
a first ultrasonic detector disposed on a side wall of the detection chamber and opposite to the first ultrasonic reflector, and configured to obtain a first flight time corresponding to an ultrasonic wave transmitted to the first ultrasonic reflector and reflected back;
a second ultrasonic reflector disposed on an elastic side wall of the detection chamber and configured to reflect an ultrasonic signal, wherein a distance of an outward expansion of the elastic side wall is related to a pressure exerted by the liquid to be measured on the outward expansion; and
a second ultrasonic detector disposed on the side wall of the detection chamber and opposite to the second ultrasonic reflector, and configured to obtain a second flight time corresponding to an ultrasonic wave transmitted to the second ultrasonic reflector and reflected back.

2. The dual ultrasonic detection device of claim 1, wherein the elastic side wall of the detection chamber is provided with a pressure-sensitive membrane.

3. The dual ultrasonic detection device of claim 2, wherein the pressure-sensitive membrane includes an elastic metal film.

4. The dual ultrasonic detection device according to claim 2, further comprising a rear cover, wherein an air cavity is formed between the pressure-sensitive membrane and the rear cover; a liquid passage passes through the housing, the liquid passage is in communication with the detection chamber, and a liquid inlet is formed at a bottom of the housing and a liquid outlet is formed at a top of the housing; the housing further includes a first through hole, through which the liquid to be measured contacts the pressure-sensitive membrane.

5. The dual ultrasonic detection device according to claim 4, wherein the housing is provided with a groove, within which a first sealing ring is disposed, and the first sealing ring is abutted against both the housing and the rear cover.

6. The dual ultrasonic detection device according to claim 4, wherein a flat surface is provided at a center of the pressure-sensitive membrane, and the flat surface transitions to a skirt that is outermost via a corrugated region.

7. The dual ultrasonic detection device according to claim 6, wherein the second ultrasonic reflector includes a metal sheet embedded in the flat surface at the center of the pressure-sensitive membrane.

8. The dual ultrasonic detection device according to claim 6, wherein the pressure-sensitive membrane is made of a highly elastic polymer material.

9. The dual ultrasonic detection device according to claim 6, wherein the pressure-sensitive membrane is made of a non-elastic polymer material, the air cavity is provided with a spring, and the spring is abutted against the center of the pressure-sensitive membrane.

10. The dual ultrasonic detection device according to claim 6, wherein each of a compression ring and a compression cup is disposed between the housing and the rear cover, and configured to clamp an outer edge of the corrugated region of the pressure-sensitive membrane; wherein the compression ring is abutted against the rear cover, the compression cup is abutted against the housing, a second through hole is formed at a bottom of the compression cup and is in communication with the first through hole, and the skirt of the pressure-sensitive membrane is abutted against each of the outer edge of the compression cup, the housing, and the rear cover.

11. The dual ultrasonic detection device according to claim 10, wherein a second sealing ring is provided between the outer edge of the compression cup and the housing.

12. The dual ultrasonic detection device according to claim 4, wherein the liquid inlet is provided with a filter.

13. The dual ultrasonic detection device according to claim 4, further comprising a circuit board, wherein the circuit board includes:
a control module correspondingly connected to the first ultrasonic detector and the second ultrasonic detector, and configured to receive and process an ultrasonic detection signal;
a timing module connected to the control module, and configured to provide timing for an ultrasonic distance measurement;
a communication module connected to the control module, and configured to communicate with a host computer to transmit data and a control signal;
a power module configured to supply a suitable power voltage to electronic components of the dual ultrasonic detection device.

14. The dual ultrasonic detection device according to claim 1, wherein a maximum distance of the outward expansion of the elastic side wall of the detection chamber is less than a product of a second flight velocity that is smallest across a full range and an ultrasonic vibration period; wherein the second flight velocity is defined as a distance between the second ultrasonic reflector and the second ultrasonic detector divided by the second flight time.
